(19) United States
(12) Patent Application Publication
(10) Pub. No.: US 2008/0202472 A1
(43) Pub. Date: Aug. 28, 2008

(54) Fuel rail support bracket

(76) Inventors: Mark Whatley, Northville, MI (US); Andy Kathiresan, Dearborn, MI (US); Jim Gavriles, Plymouth, MI (US); Tedd LaPorte, Canton, MI (US); Gerard N. Panasuk, Hartland, MI (US)

Correspondence Address: AUTOMOTIVE COMPONENTS HOLDINGS LLC;C/O MACMILLAN, SOBANSKI & TODD, LLC, ONE MARITIME PLAZA, FIFTH FLOOR, 720 WATER STREET, TOLEDO, OH, 43604-1853, US

(21) Appl. No.: 11/712,378

(22) Filed: Feb. 28, 2007

(51) Int. Cl. F02M 69/46

(52) U.S. Cl. 123/469; 123/468

(57) ABSTRACT

A fuel rail mounting bracket for use in a fuel charging assembly of a vehicle engine is disclosed. The fuel rail mounting bracket may include a bolt support portion mounted to the vehicle engine; a transition zone extending from the bolt support portion; and a support hoop portion extending from the transition zone and supportably mounted around the fuel rail, the support hoop portion having a main wall thickness and including an upper fracture recess adjacent to the transition zone that has an upper fracture wall thickness that is less than the main wall thickness, and a lower fracture recess, adjacent to the transition zone and spaced from the upper fracture recess, having a lower fracture wall thickness that is less than the main wall thickness.

### BACKGROUND OF INVENTION

The present invention relates to a fuel rail assembly for use with an internal combustion engine of an automotive vehicle, and more particularly to one or more support brackets for such a fuel rail assembly.

In some transverse mounted engines employed in automotive vehicles, an air intake manifold is located in front of the engine block, with a fuel charging assembly located between portions of the intake manifold and the engine block/head. In particular, a fuel rail, with fuel injectors extending from the fuel rail, may be mounted between the intake manifold and engine block/heads. With such an arrangement, a rearward acting impact force acting upon the forward side of the intake manifold may push the manifold backwards toward the fuel rail and fuel injectors. It is generally considered undesirable to have the intake manifold, during an impact event, impinge upon the fuel charging assembly in such a way that one or more of the fuel injectors disengage from the fuel rail.

More recently, some have tried to address this concern. One proposed solution employs a metal protector that extends along the entire length of and surrounds portions of the fuel rail and fuel injectors. During an impact event, portions of the intake manifold moving rearward impact the metal protector, causing it to deform and wrap itself partially around the fuel rail in an attempt to protect it. Another proposed solution uses a protective strap extending longitudinally along the entire length of and spaced from the fuel rail toward the direction of the impact force in order to block portions of the intake manifold from impacting the fuel rail during an impact event. While satisfactory, it is desired to have an improved way to address the particular concern that may arise during an impact event.

### SUMMARY OF INVENTION

An embodiment contemplates a fuel rail mounting bracket for use in a fuel charging assembly of a vehicle engine. The fuel rail mounting bracket may comprise a bolt support portion mounted to the vehicle engine; a transition zone extending from the bolt support portion; and a support hoop portion extending from the transition zone and defining a fuel rail support channel extending therethrough and mounted around a fuel rail of the fuel charging assembly, the support hoop portion having a main wall thickness and including a lower fracture recess adjacent to the transition zone that has a lower fracture wall thickness that is less than the main wall thickness.

An embodiment contemplates a fuel charging assembly for a vehicle engine that may comprise a fuel rail, a fuel injector, a fuel rail mounting bracket, and a mounting bolt. The fuel rail contains fuel therein, and the fuel injector is sealingly mounted to and extends from the fuel rail. The fuel rail mounting bracket includes a bolt support portion mountable to the vehicle engine; a transition zone extending from the bolt support portion; and a support hoop portion extending from the transition zone and supportably mounted around the fuel rail, the support hoop portion having a main wall thickness and including an upper fracture recess adjacent to the transition zone that has an upper fracture wall thickness that is less than the main wall thickness. The mounting bolt extends through the bolt support portion and engages with the vehicle engine.

An embodiment contemplates a transverse engine for use in an automotive vehicle comprising: an engine block including a fuel assembly mounting boss, an intake manifold located in front of the engine block, a fuel rail mounted between the intake manifold and the engine block, a fuel injector sealingly mounted to and extending from the fuel rail, a fuel rail mounting bracket, and a mounting bolt. The fuel rail mounting bracket may include a bolt support portion mounted to the vehicle engine; a transition zone extending from the bolt support portion; and a support hoop portion extending from the transition zone and supportably mounted around the fuel rail, the support hoop portion having a main wall thickness and including an upper fracture recess adjacent to the transition zone that has an upper fracture wall thickness that is less than the main wall thickness, and a lower fracture recess, adjacent to the transition zone and spaced from the upper fracture recess, having a lower fracture wall thickness that is less than the main wall thickness. The mounting bolt extends through the bolt support portion and engages with the fuel assembly mounting boss.

An advantage of an embodiment is that upon an impact event that pushes an intake manifold into a fuel charging assembly, the fuel rail mounting brackets fracture in order to allow the fuel injectors to stay engaged with the fuel rail.

### BRIEF DESCRIPTION OF DRAWINGS

FIG. 1 is a perspective view of a portion of a vehicle engine.

FIG. 2 is a perspective view of a portion of a fuel charging assembly.

FIG. 3 is a perspective view of a portion of a fuel rail, with a fuel injector and fuel rail mounting bracket mounted on the fuel rail.

FIG. 4 is a perspective view, on an enlarged scale, of components similar to FIG. 3 but looking up at the underside of the fuel rail.

FIG. 5 is a partially exploded perspective view of a portion of the fuel rail and fuel rail mounting bracket.

FIG. 6 is a perspective view of the fuel rail mounting bracket.

FIG. 7 is a perspective view, similar to FIG. 6, but looking up at the underside of the bracket.

FIG. 8 is a view similar to FIG. 4, but illustrating the bracket after an impact force has caused the bracket to fracture.

### DETAILED DESCRIPTION

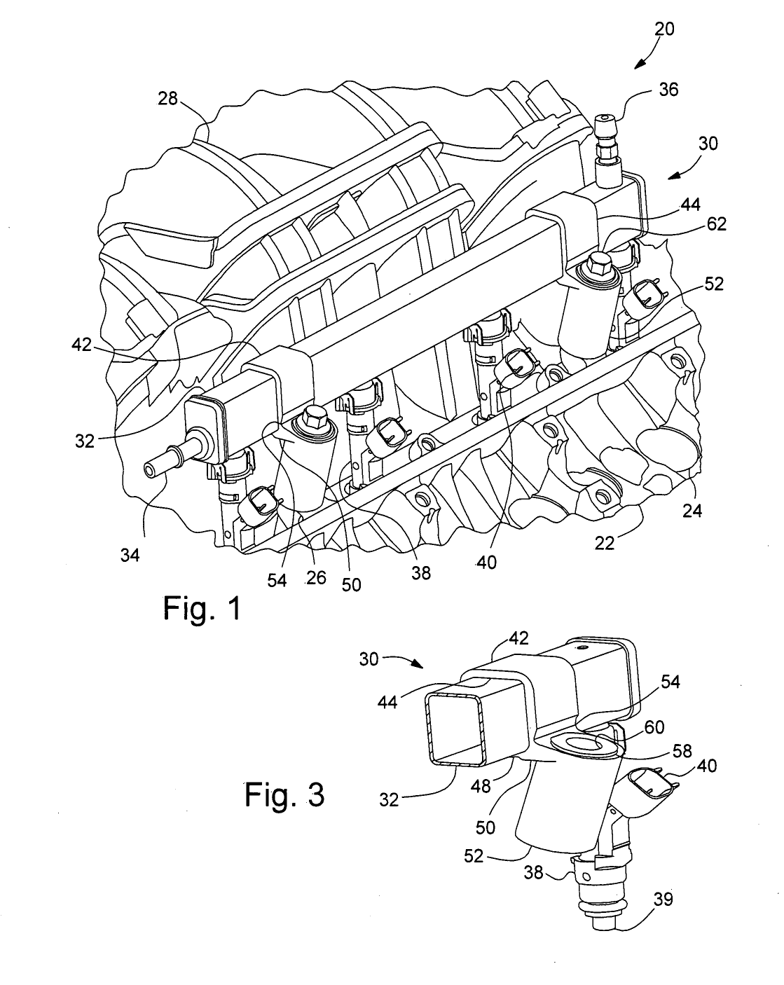

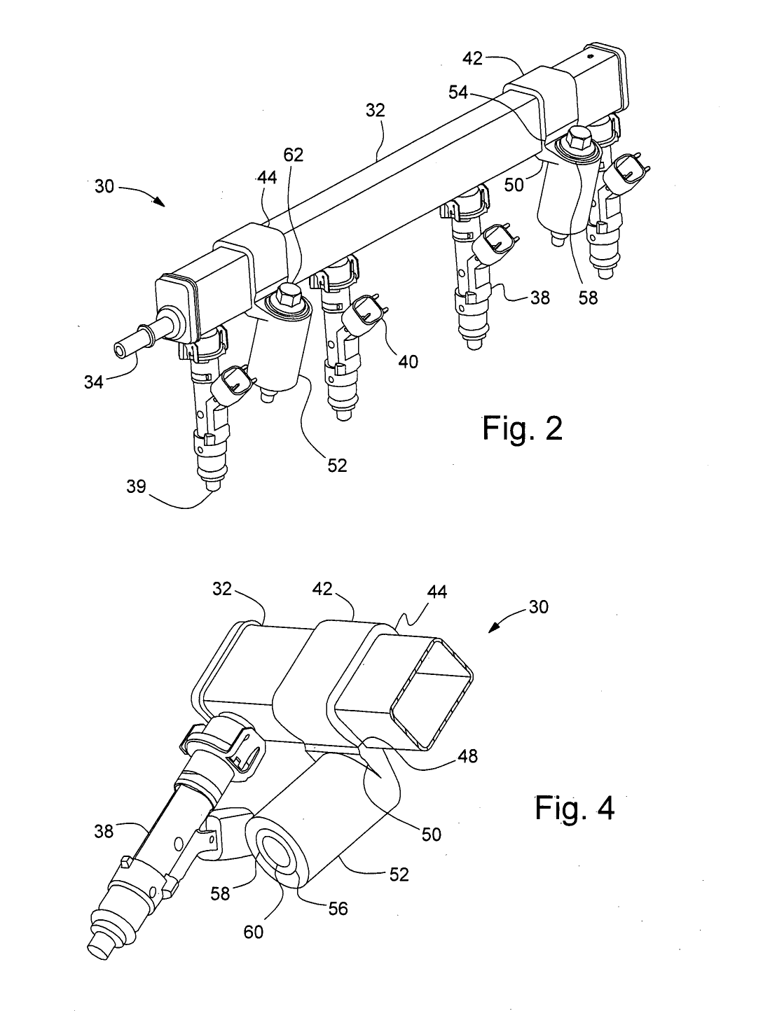

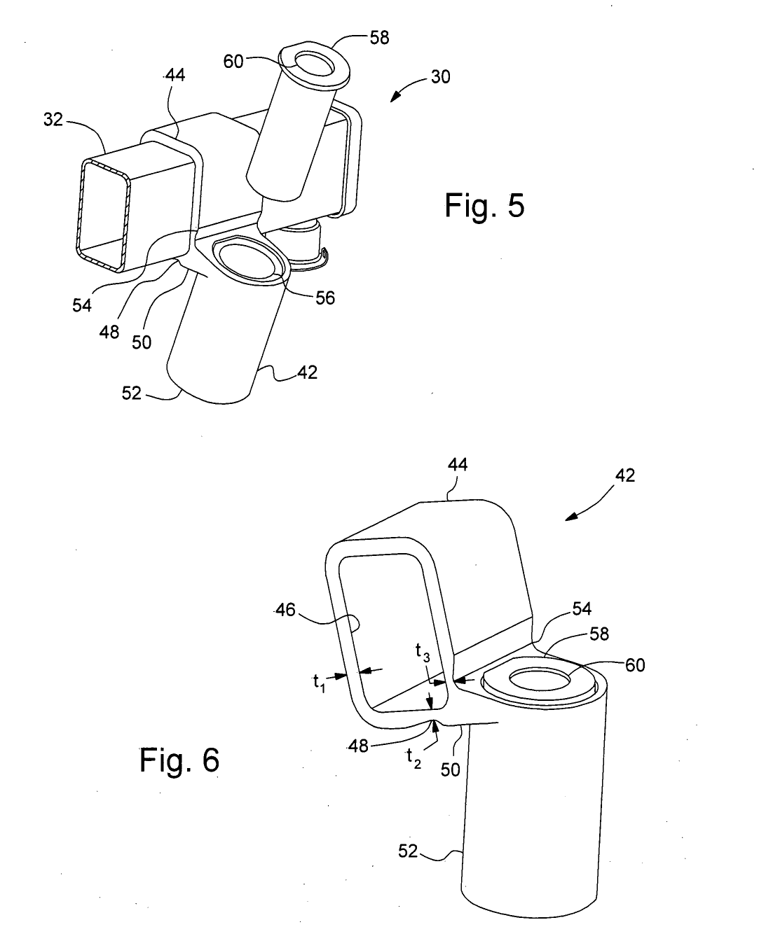

FIGS. 1-7 illustrate portions of a transverse mounted engine, indicated generally at 20, for use in an automotive vehicle (not shown). The engine 20 includes a block 22, upon which a cylinder head (not shown) mounts, having cylinders 24 formed therein. Fuel assembly mounting bosses 26 extend from the block 22. Located in front of the block 22 is an air intake manifold 28, which is typically made of a plastic material. A fuel charging assembly 30 is located generally between the block 22 and the intake manifold 28.

The fuel charging assembly 30 includes a hollow fuel rail 32, having a first fuel line connector 34 at one end and a second fuel line connector 36 at an opposed end. The fuel rail 32 may be made of metal. Four fuel injectors 38 are mounted to the fuel rail 32 and seal with the fuel rail 32 to prevent fuel from leaking out at the connections. The fuel injectors 38 extend down into engagement with the block 22, each including a nozzle 39 adjacent to one of the four cylinders 24. The fuel injectors 38 also include electrical connectors 40 for actuating the injectors 38.

A pair of fuel rail mounting brackets 42 support the fuel rail 32. The fuel rail mounting brackets 42 are preferably formed of a plastic that is not elastomeric like a rubber compound, but has characteristics such that inducing strain beyond a certain amount will cause the material to fracture. The reason for this will become apparent in light of the discussion below.

Each fuel rail bracket 42 includes a fuel rail support hoop 44 that defines a fuel rail support channel 46, within which the fuel rail 32 is mounted. A lower fracture recess 48 extends across the hoop 44 on a first side of a transition zone 50—extending to a bolt support portion 52—and an upper fracture recess 54 extends across the hoop 44 on a second side of the transition zone 50. The fuel rail support hoop 44 may be rectangular in shape, with the transition zone 50 connecting to the hoop 44 at a corner of the hoop 44.

Each of the fuel rail support hoops 44 has a main wall thickness t₁ that extends around most of the hoop 44, a lower fracture wall thickness t₂ at the lower fracture recess 48, and an upper fracture wall thickness t₃ at the upper fracture recess 54. The lower fracture wall thickness t₂ and the upper fracture wall thickness t₃ are each thinner than the main wall thickness t₁. These thin wall sections created by the lower fracture recess 48 and upper fracture recess 54 cause both of these areas to be lines of weakness in the fuel rail support hoop 44, the purpose of which will be described below.

The bolt support portions 52, of the fuel rail mounting brackets 42, are each cylindrical in shape and extend down into engagement with corresponding fuel assembly mounting bosses 26. Insert bores 56 extend through each of the bolt support portions 52. Mounting bolt inserts 58 are mounted in the insert bores 56 and include bolt holes 60 therethrough. The bolt holes 60 align with threaded holes (not shown) in the mounting bosses 26. Mounting bolts 62 extend through the bolt holes 60 and thread into the mounting bosses 26 in order to secure the fuel charging assembly 30 to the engine block 22.

Under normal vehicle operating conditions, the fuel rail mounting brackets 42 support the fuel rail 32 and maintain it in its proper position relative to the engine block 22. Thus, the fuel injectors 38 are also held in their proper positions relative to the block 22. Upon a frontal impact event to the vehicle, however, portions of the intake manifold 28 can be pushed back toward the fuel charging assembly 30.

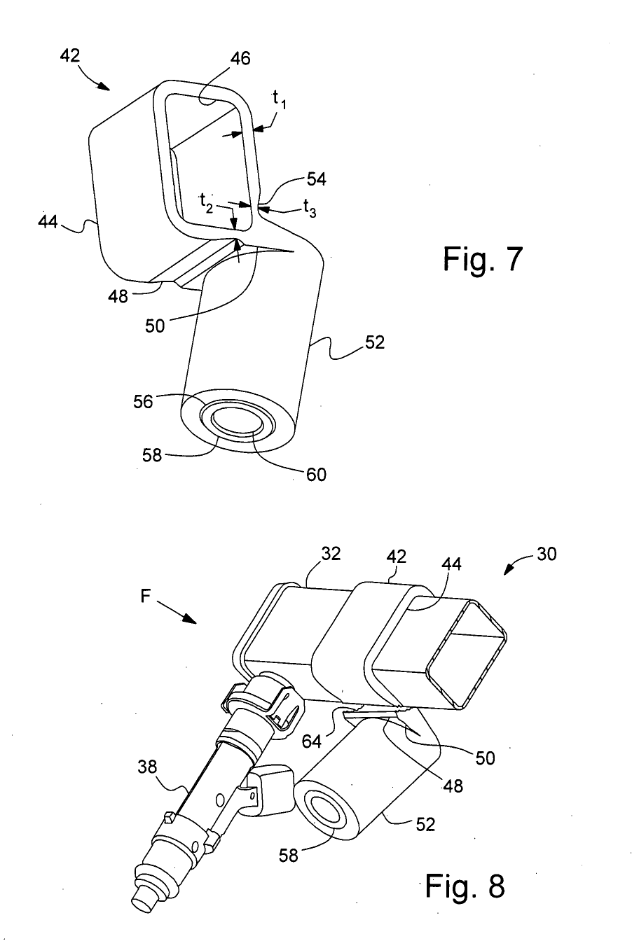

FIG. 8 illustrates one of the fuel rail mounting brackets 42 after an impact event has pushed the intake manifold (shown in FIG. 1) into the fuel charging assembly 30. As the manifold pushes back into the fuel charging assembly 30, force in the direction of arrow F is applied to the fuel rail 32 and fuel injectors 38. As the fuel rail 32 starts to move in the direction of the force, the support hoops 44 will begin to pivot about the transition zones 50 due to the fact that the bolt support portions 52 are firmly secured to the fuel assembly mounting bosses 26 (shown in FIG. 1) by the mounting bolts 62 (shown in FIG. 1) while the support hoops 44 are secured to the fuel rail 32. As the fuel rail 32 and support hoops 44 move, flexing will occur at the lower fracture recesses 48 and the upper fracture recesses 54 (shown in FIG. 7) since the reduced thicknesses t₂ and t₃ (shown in FIG. 7) create lines of weakness. Continued movement will cause the thin material at these recesses 48, 54 to break, creating fractures 64 (one shown in FIG. 8). By allowing the fuel rail mounting brackets 42 to fracture, the fuel rail 32 can continue moving backward toward the engine block 22 (shown in FIG. 1) with the fuel injectors 38, thus allowing the fuel injectors 38 to stay engaged with the fuel rail 32 during the impact event.

While certain embodiments of the present invention have been described in detail, those familiar with the art to which this invention relates will recognize various alternative designs and embodiments for practicing the invention as defined by the following claims.

1. A fuel rail mounting bracket for use in a fuel charging assembly of a vehicle engine, the fuel rail mounting bracket comprising:
a bolt support portion mountable to the vehicle engine;
a transition zone extending from the bolt support portion; and
a support hoop portion extending from the transition zone and defining a fuel rail support channel extending therethrough and mountable around a fuel rail of the fuel charging assembly, the support hoop portion having a main wall thickness and including a lower fracture recess adjacent to the transition zone that has a lower fracture wall thickness that is less than the main wall thickness.

2. The fuel rail mounting bracket of claim 1 wherein the support hoop portion includes an upper fracture recess, adjacent to the transition zone and spaced from the lower fracture recess, having an upper facture wall thickness that is less than the main wall thickness.

3. The fuel rail mounting bracket of claim 1 wherein the hoop support portion is made of plastic.

4. The fuel rail mounting bracket of claim 1 wherein the bolt support portion includes an insert bore and a mounting bolt insert mounted within the insert bore, the mounting bolt insert including a bolt hole for receiving a mounting bolt securable to the vehicle engine.

5. The fuel rail mounting bracket of claim 4 wherein the support hoop portion is rectangular in shape and the transition zone extends from a corner of the support hoop.

6. The fuel rail mounting bracket of claim 5 wherein the support hoop portion includes an upper fracture recess, adjacent to the transition zone and spaced from the lower fracture recess, having an upper facture wall thickness that is less than the main wall thickness.

7. The fuel rail mounting bracket of claim 4 wherein the support hoop portion includes an upper fracture recess, adjacent to the transition zone and spaced from the lower fracture recess, having an upper facture wall thickness that is less than the main wall thickness.

8. The fuel rail mounting bracket of claim 1 wherein the support hoop portion is rectangular in shape and the transition zone extends from a corner of the support hoop.

9. The fuel rail mounting bracket of claim 1 wherein the bolt support portion, the transition zone, and the support hoop portion are made of plastic.

10. A fuel charging assembly for a vehicle engine comprising:
a fuel rail for containing fuel therein;
a fuel injector sealingly mounted to and extending from the fuel rail;
a fuel rail mounting bracket including a bolt support portion mountable to the vehicle engine; a transition zone extending from the bolt support portion; and a support hoop portion extending from the transition zone and supportably mounted around the fuel rail, the support hoop portion having a main wall thickness and including an upper fracture recess adjacent to the transition zone that has an upper fracture wall thickness tat is less than the main wall thickness; and
a mounting bolt extending through the bolt support portion and threadably engageable with the vehicle engine.

11. The fuel charging assembly of claim 10 wherein the support hoop portion includes a lower fracture recess, adjacent to the transition zone and spaced from the upper fracture recess, having a lower fracture wall thickness that is less than the main wall thickness.

12. The fuel charging assembly of claim 11 including a second fuel rail mounting bracket, spaced from the fuel rail mounting bracket, and a second mounting bolt, the second fuel rail mounting bracket including a second bolt support portion mountable to the vehicle engine; a second transition zone extending from the second bolt support portion; and a second support hoop portion extending from the second transition zone and supportably mounted around the fuel rail, the second support hoop portion having a second main wall thickness and including a second upper fracture recess adjacent to the second transition zone that has a second upper fracture wall thickness that is less than the second main wall thickness, and a second lower fracture recess, adjacent to the second transition zone and spaced from the second upper fracture recess, having a second lower fracture wall thickness that is less than the second main wall thickness.

13. The fuel charging assembly of claim 10 including a second fuel rail mounting bracket, spaced from the fuel rail mounting bracket, and a second mounting bolt, the second fuel rail mounting bracket including a second bolt support portion mountable to the vehicle engine; a second transition zone extending from the second bolt support portion; and a second support hoop portion extending from the second transition zone and supportably mounted around the fuel rail, the second support hoop portion having a second main wall thickness and including a second upper fracture recess adjacent to the second transition zone that has a second upper fracture wall thickness that is less than the second main wall thickness.

14. The fuel charging assembly of claim 10 wherein the bolt support portion includes an insert bore and a mounting bolt insert mounted within the insert bore, the mounting bolt insert including a bolt hole for receiving the mounting bolt therethrough.

15. The fuel charging assembly of claim 10 wherein the support hoop portion is rectangular in shape and the transition zone extends from a corner of the support hoop portion.

16. The fuel charging assembly of claim 15 wherein the support hoop portion includes a lower fracture recess, adjacent to the transition zone and spaced from the upper fracture recess, having a lower fracture wall thickness that is less than the main wall thickness.

17. A transverse engine for use in an automotive vehicle comprising:
an engine block including a fuel assembly mounting boss;
an intake manifold located in front of the engine block;
a fuel rail mounted between the intake manifold and the engine block;
a fuel injector sealingly mounted to and extending from the fuel rail;
a fuel rail mounting bracket including a bolt support portion mounted to the vehicle engine; a transition zone extending from the bolt support portion; and a support hoop portion extending from the transition zone and supportably mounted around the fuel rail, the support hoop portion having a main wall thickness and including an upper fracture recess adjacent to the transition zone that has an upper fracture wall thickness that is less than the main wall thickness, and a lower fracture recess, adjacent to the transition zone and spaced from the upper fracture recess, having a lower fracture wall thickness that is less than the main wall thickness; and
a mounting bolt extending through the bolt support portion and threadably engaged with the fuel assembly mounting boss.

18. The engine of claim 17 including a second fuel rail mounting bracket, spaced from the fuel rail mounting bracket, and a second mounting bolt, the second fuel rail mounting bracket including a second bolt support portion mountable to the vehicle engine; a second transition zone extending from the second bolt support portion; and a second support hoop portion extending from the second transition zone and supportably mounted around the fuel rail, the second support hoop portion having a second main wall thickness and including a second upper fracture recess adjacent to the second transition zone that has a second upper fracture wall thickness that is less than the second main wall thickness, and a second lower fracture recess, adjacent to the second transition zone and spaced from the second upper fracture recess, having a second lower fracture wall thickness that is less than the second main wall thickness.

19. The engine of claim 18 wherein the fuel rail mounting bracket an the second fuel rail mounting bracket are made of plastic.

20. The engine of claim 17 wherein the support hoop portion is rectangular in shape and the transition zone extends from a corner of the support hoop portion.

21. The fuel rail mounting bracket of claim 1 wherein the support hoop portion is rectangular in shape and the transition zone extends from a corner of the support hoop, the support hoop portion including an upper fracture recess adjacent to the corner on one side the transition zone relative to the corner, with the lower facture recess being adjacent to the corner on an opposite side of the transition zone relative to the corner.

22. The fuel rail mounting bracket of claim 1 wherein the support hoop portion includes a manifold impact side facing in a direction toward an air intake manifold, with the transition zone being located on an opposite side of the support hoop portion from the manifold impact side.

23. The fuel rail mounting bracket of claim 1 wherein the support hoop portion includes opposed open ends relative to the fuel rail support channel, and the lower fracture recess extends entirely between the opposed open ends.

24. The fuel rail mounting bracket of claim 1 wherein the fuel rail support channel extends along a first axis and the bolt support portion includes an insert bore that extends along a second axis that is oblique relative to the first axis.
